(19) United States
(12) Patent Application Publication
(10) Pub. No.: US 2003/0177653 A1
(43) Pub. Date: Sep. 25, 2003

(54) Sensor for a machine for measuring three-dimensional coordinates

(76) Inventor: Romain Granger, Lavardin (FR)

Correspondence Address: YOUNG & THOMPSON, 745 SOUTH 23RD STREET 2ND FLOOR, ARLINGTON, VA, 22202

(21) Appl. No.: 10/390,008

(22) Filed: Mar. 18, 2003

(30) Foreign Application Priority Data
Mar. 19, 2002 (FR) 0203367

(51) Int. Cl. G01B 5/00

(52) U.S. Cl. 33/556

(57) ABSTRACT

A sensor for a machine for measuring three-dimensional coordinates, the sensor comprising a portion enabling it to be fixed to the end of a moving arm, and an active portion remote from said fixing portion, including a connection element between the active portion and the connection portion, thereby forming a mechanical joint having at least one degree of freedom.

The present invention relates to machines for measuring three-dimensional coordinates, and in particular it relates to the sensors situated at the ends of the hinged arms thereof.

### BACKGROUND OF THE INVENTION

A three-dimensional article is defined in space by its position and its orientation. A known measuring machine comprises a moving arm having first and second opposite ends, the arm including a plurality of mechanical joints, each joint corresponding to one degree of freedom, with each of the joints comprising a rotary transmission unit containing a position transducer (coder), the transducer (coder) producing a position signal. A base supports a first end of the moving arm and a sensor is fixed to its second end. An electronic circuit in the form of an operating unit receives the position signals coming from the transducers to produce a digital coordinates corresponding to the position of the sensor in a volume identified relative to a frame of reference.

The machines in most common use generally have six successive degrees of freedom starting from the base and going to the sensor. Together with its associated electronics, such an arm forms an assembly which merely needs to be connected to a signal processor unit or to an operating system (for example a personal computer). The assembly is remarkable in particular in that all of the conductor wires connecting the transducers to a power supply and to the system for making use of the signals issued are enclosed within each section of the arm and in the joints.

There exist machines having an additional degree of freedom. However such machines are relatively uncommon and they are therefore expensive. The difficulty is that this seventh degree of freedom is not always necessary.

### OBJECTS AND SUMMARY OF THE INVENTION

For the purpose of satisfying this requirement which suffers from being marginal, the invention provides a sensor for a machine for measuring three-dimensional coordinates, the sensor comprising a portion enabling it to be fixed to the end of a moving arm, and an active portion remote from said fixing portion, and between the active portion and the fixing portion, a connection element forming a mechanical joint having at least one degree of freedom. By means of such a sensor, it is possible to convert a conventional measuring machine having five or six axes into a machine having six or seven axes or even more, and to do this without needing to invest in the purchase of a special machine that is relatively uncommon and expensive.

The degree of freedom of the joint incorporated in the sensor may either be a degree of freedom in translation or else a degree of freedom in rotation.

In a particular embodiment, the degree of freedom of at least one joint is restricted to a plurality of predetermined positions with each of the positions being indexed. It has been found that in certain cases it suffices merely to be able to orient the active portion of the sensor relative to its fixing portion on the arm in order to satisfy particular measurement requirements.

The mechanical joint includes a coder associated therewith that produces a position signal, and means for communicating with an electronic control unit belonging to the machine for measuring coordinates in three dimensions. With this disposition, it suffices to provide an additional inlet/outlet in the electronic control unit for processing the signal and suitable for operating a conventional machine in order to be able to take into account the degree of freedom of the sensor. The communications means preferably comprise a set of electronic circuits on board the sensor, said circuits serving to control the operation of the sensor itself (e.g. a Renishaw probe), to control communication between the sensor and the central processor unit, to control the electrical power supply to the sensor, if necessary, to constitute a counter where appropriate, and to enable measurement pulses to be sent and received, . . .

### BRIEF DESCRIPTION OF THE DRAWINGS

Other characteristics and advantages of the invention appear from the description given below of a few embodiments.

Reference is made to the accompanying drawings, in which:

FIG. 1 is a diagram of a machine having six degrees of freedom;

FIG. 2 is a diagram of a first embodiment of the sensor of the invention;

FIG. 3 is a diagram of a second embodiment of the sensor;

FIG. 4 is a diagram of a third embodiment of the sensor; and

FIG. 5 is a diagram of a fourth embodiment of the sensor.

### MORE DETAILED DESCRIPTION

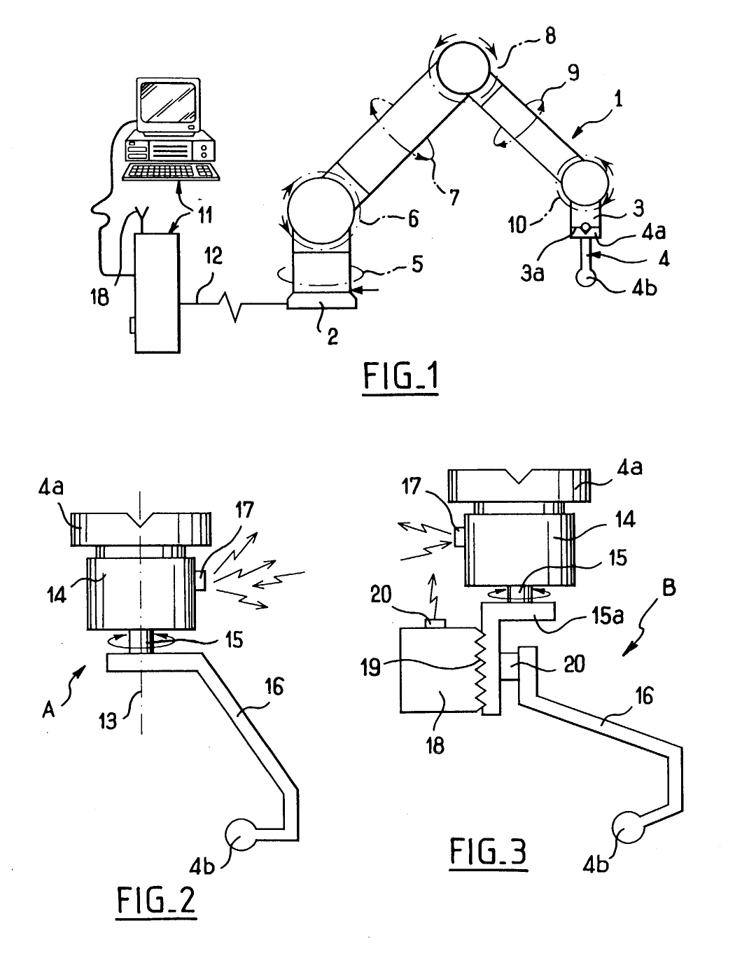

The machine of FIG. 1 comprises an arm 1 having a first end 2 and a second end 3 forming the support of a sensor 4. Between its two ends, the arm has six degrees of freedom (axes), all in rotation and identified by arrows 5 to 10.

An (electronic) computer unit for controlling, processing, and operating the measurement machine is referenced 11. Each of the coders associated with a respective degree of freedom is connected to the processor unit 11 over a wire link 12 which is integrated inside the arm. The sensor 4 (probe or feeler) is fixed via a portion 4a to the end 3 of the arm 1 which is provided for this purpose with a plate 3a for receiving this portion 4a. This is achieved in a position that is precise and known to the operating unit 11 of the machine. The two parts 3a and 4a are indexed in this precise position in a manner that is symbolized by cooperation between V-grooves and cylinders that are themselves conventional. The sensor 4 possesses an active end portion 4b represented herein as being in the form of a feeler ball.

The first embodiment of a sensor of the invention as shown in FIG. 2 comprises a feeler A with, as described above, a fixing portion 4a and an active portion 4b in the form of a small sphere.

The portions 4a and 4b are interconnected by a connection element which includes a mechanical hinge joint with one degree of freedom in rotation about an axis 13. In this configuration, the connection element comprises a unit 14 provided with internal bearings for a shaft 15 on the axis 13 and secured to an arm 16 carrying at its end the feeler ball 4b. In conventional manner, the unit 14 contains a coder capable of issuing signals representative of the position of the arm 15 relative to the unit 14. By means of appropriate electronics, powered externally or internally (i.e. using a battery if necessary), these signals are issued by means of a radio or infrared transmitter 17 to be received by an antenna 18 of the central unit 11 for operating the machine. It should be observed that the transmitter member 17 may also have a receiver for receiving instructions coming from the central unit 11 via a transmission antenna such as 18 (measurement pulses, data interchange while calibrating the machine fitted with the sensor, . . . ). In a variant that is not shown, the connection between the central unit 11 and the sensor A of the invention can be provided by means of an electric cable.

FIG. 3 shows a variant embodiment B of the feeler A of FIG. 2. The connection element between the portions 4a and 4b of the feeler B comprise the same unit 14 as described above together with a shaft 15 and a transceiver 17. The shaft 15 is connected at its end to a bracket 15a carrying a second unit 18 which, by means of a set of teeth 19 or by any other means, serves to fix a shaft 20 in one out of a plurality of positions relative to the bracket 15a, with the arm 16 being secured to the shaft 20. A coder or any other equivalent means associated with the unit 18 and with the shaft 20 is capable by means of a transmitter 21 of transmitting a signal to the unit 11 representative of the selected indexing position. In a simpler variant embodiment, the position of the assembly 18 & 20 relative to the bracket 15a can be identified and input manually into the control unit via an input member. This makes it possible to omit communications means such as the means 21. The sensor B of the invention is a sensor having two degrees of freedom (two axes), one of which is restricted to a plurality of predetermined positions. A variant embodiment would consist in providing a degree of freedom in rotation without limit between the shaft 20 and the bracket 15a, as between the unit 14 and the shaft 15.

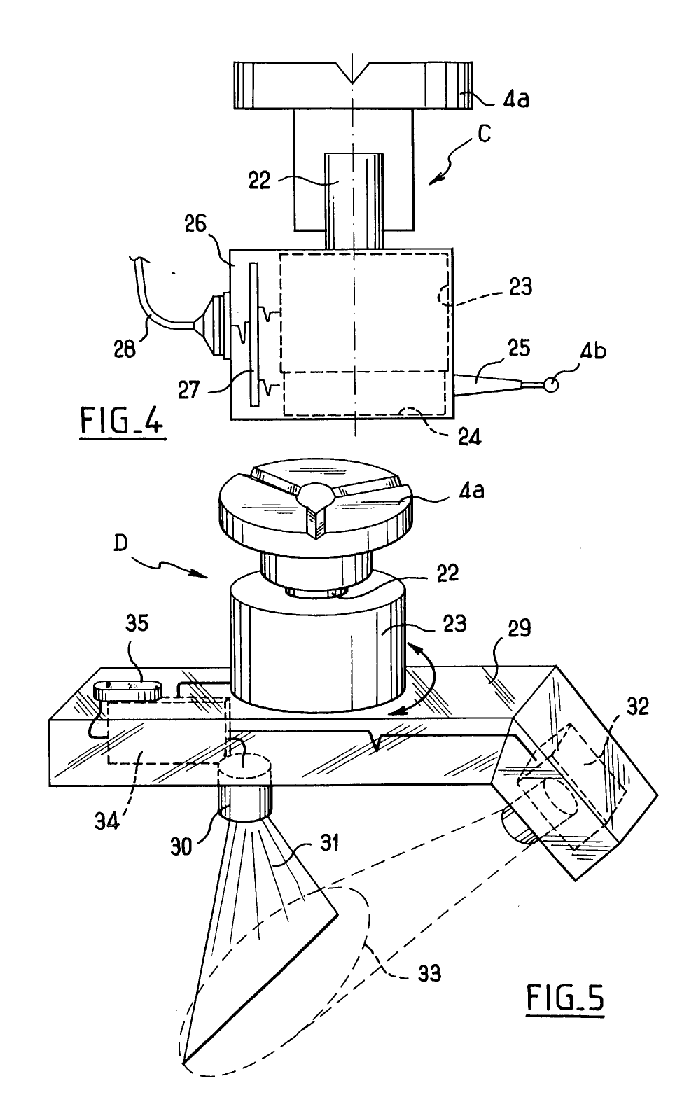

The sensor C of the invention as shown in FIG. 4 comprises, as before, a fixing portion 4a and a feeler ball 4b. A connection is provided between these two elements by means of a shaft 22 constrained to rotate with the connection portion 4a and about which a unit 23 associated with a coder is capable of turning. This unit 23 is secured to the structure 24 of a sensor 25 of the Renishaw type carrying a feeler ball 4b at its end. The unit 23 and the sensor structure 24 are united in a case 26 which encloses an electronic circuit card 27 for local control of the active portion of the sensor and for communication with the central unit 11, having both coder electronics associated with the unit 23 and electronics associated with the Renishaw sensor 25. The decentralized electronic circuit 27 is connected to the central unit 11 by means of a cable 28.

Finally, the sensor D as shown in FIG. 5 is such that like the sensor C, the unit 23 is free to turn relative to the fixing portion 4a constrained in rotation relative to the shaft 22 coming from the unit 23. A structure 29 is secured to the unit 23 and comprises, for example, a light source 30 emitting a plane laser beam 31 and a camera 32 for observing a scene 33 where the beam 31 intersects the object to be scanned. An electronics card 34 provides local control over the source 30, the camera 32, and the coder integrated in the unit 23, this electronics card communicating with the central unit 11 by means of a cable that can be connected to the sensor via a socket 35, for example.

In the examples of sensors shown in the figures and described above, the degrees of freedom shown are in rotation. It would not go beyond the ambit of the invention to provide a degree of freedom in translation, for example in the embodiment shown in FIG. 5 where in a determined application it would be appropriate for the structure 29 to be capable of moving in measurable manner away from or towards the portion 4a for fixing the sensor to the arm of the machine having five or six axes.

What is claimed is:

1. A sensor for a machine for measuring three-dimensional coordinates, the sensor comprising a portion enabling it to be fixed to the end of a moving arm, and an active portion remote from said fixing portion, the sensor including a connection element between the active portion and the connection portion, said connection element forming a mechanical joint having at least one degree of freedom.

2. A sensor according to claim 1, wherein the degree of freedom of the joint is a degree of freedom in translation.

3. A sensor according to claim 1, wherein the degree of freedom of the joint is a degree of freedom in rotation.

4. A sensor according to claim 1, wherein each degree of freedom of the joint is restricted to a plurality of predetermined positions, each of which is indexed.

5. A sensor according to claim 1, wherein the mechanical joint includes a coder associated therewith producing a position signal, and communications means in communication with an electronic control unit belonging to the three-dimensional coordinate measurement machine.

6. A sensor according to claim 5, wherein the communications means comprise a set of electronic circuits on board the sensor.
